(19) United States
(12) Patent Application Publication
(10) Pub. No.: US 2025/0342228 A1
(43) Pub. Date: Nov. 6, 2025

(54) STATISTICAL VALUE CALCULATION APPARATUS, PROPAGATION DELAY MEASUREMENT SYSTEM, STATISTICAL VALUE CALCULATION METHOD, AND NON-TRANSITORY COMPUTER READABLE MEDIUM

(71) Applicant: Mitsubishi Electric Corporation, Tokyo (JP)

(72) Inventor: Daisuke OSAGAWA, Tokyo (JP)

(73) Assignee: Mitsubishi Electric Corporation, Tokyo (JP)

(21) Appl. No.: 19/266,990

(22) Filed: Jul. 11, 2025

Related U.S. Application Data
(63) Continuation of application No. PCT/JP2023/007665, filed on Mar. 1, 2023.

(51) Int. Cl. G06F 17/18

(52) U.S. Cl. CPC G06F 17/18

(57) ABSTRACT

A statistical value calculation apparatus (100) includes a variation calculation unit (110). When a model indicating that a variation in propagation delay consists of a variation in variable delay and a variation in fixed delay is assumed as a propagation delay model indicating the variation in the propagation delay, in which the propagation delay is a delay that occurs at a measurement object (400) which relays data in a wired network, the variable delay is a delay that varies while the measurement object (400) is in continuous operation, and the fixed delay is a delay that varies each time the measurement object (400) is activated, and when activation of the measurement object (400) is performed multiple times and a plurality of propagation delays at the measurement object (400) in continuous operation are measured each time activation of the measurement object (400) is performed, the variation calculation unit (110) measures the fixed delay based on the plurality of propagation delays measured at the measurement object (400) in continuous operation upon each activation of the measurement object (400), and calculates the variation in the fixed delay based on the plurality of measured fixed delays.

### CROSS REFERENCE TO RELATED APPLICATION

This application is a Continuation of PCT International Application No. PCT/JP2023/007665, filed on Mar. 1, 2023, which is hereby expressly incorporated by reference into the present application.

### TECHNICAL FIELD

The present disclosure relates to a statistical value calculation apparatus, a statistical value calculation method, and a statistical value calculation program.

### BACKGROUND ART

In an FA (Factory Automation) network, time synchronization error in the entire network needs to be ensured. A major cause of a time synchronization error is a variation in propagation delay among communication stations and communication channels. The variation in the propagation delay is the difference between a maximum value of the propagation delay and a minimum value of the propagation delay. Thus, it is desired to predict the variation in the propagation delay in an FA network.

Patent Literature 1 discloses a technique that measures the propagation delay at a measurement object which is in continuous operation multiple times and estimates the variation in the propagation delay from the distribution of multiple propagation delays measured. Conventional techniques, including Patent Literature 1, commonly measure the propagation delay at a measurement object being in continuous operation.

### CITATION LIST

### Patent Literature

Patent Literature 1: JP 2014-022918 A

### SUMMARY OF INVENTION

### Technical Problem

In an FA network, the variation in the propagation delay at a measurement object is considered to consist of a variation in fixed delay and a variation in variable delay. Here, a fixed delay is a delay that varies in value each time the measurement object is activated. A variable delay is a delay that varies in value within a constant range regardless of the timing of activating the measurement object.

The conventional techniques have an issue of not taking into account the variation in the fixed delay in assessment of the variation in the propagation delay.

The present disclosure aims at taking into account the variation in the fixed delay in assessment of the variation in the propagation delay at the measurement object in an FA network.

### Solution to Problem

A statistical value calculation apparatus according to the present disclosure includes:
when a model indicating that a variation in propagation delay consists of a variation in variable delay and a variation in fixed delay is assumed as a propagation delay model indicating the variation in the propagation delay, wherein the propagation delay is a delay that occurs at a measurement object which relays data in a wired network, the variable delay is a delay that varies while the measurement object is in continuous operation, and the fixed delay is a delay that varies each time the measurement object is activated; and when activation of the measurement object is performed multiple times and a plurality of propagation delays at the measurement object in continuous operation are measured each time activation of the measurement object is performed,
a variation calculation unit
   to measure the fixed delay based on the plurality of propagation delays measured at the measurement object in continuous operation as an object fixed delay upon each activation of the measurement object, and
   to calculate the variation in the fixed delay based on the plurality of measured object fixed delays.

### Advantageous Effects of Invention

According to the present disclosure, the variation calculation unit measures the fixed delay based on multiple propagation delays measured at the measurement object in continuous operation, and calculates the variation in the fixed delay based on multiple fixed delays measured. Here, the measurement object may be a device as a component of an FA network. Also, the calculated variation in the fixed delay may be taken into consideration in assessment of the variation in the propagation delay. Thus, according to the present disclosure, the variation in the fixed delay can be taken into consideration in assessment of the variation in the propagation delay at the measurement object in an FA network.

### BRIEF DESCRIPTION OF DRAWINGS

FIG. 1 shows a configuration example of a propagation delay measurement system 90 according to Embodiment 1.

FIG. 2 is a diagram illustrating propagation delays according to Embodiment 1.

FIG. 3 shows a hardware configuration example of a statistical value calculation apparatus 100 according to Embodiment 1.

FIG. 4 is a flowchart illustrating the operation of the propagation delay measurement system 90 according to Embodiment 1.

FIG. 5 shows a hardware configuration example of the statistical value calculation apparatus 100 according to a modification of Embodiment 1.

FIG. 6 is a flowchart illustrating the operation of the propagation delay measurement system 90 according to Embodiment 2.

FIG. 7 is a flowchart illustrating the operation of the propagation delay measurement system 90 according to a modification of Embodiment 2.

FIG. 8 is a flowchart illustrating the operation of the propagation delay measurement system 90 according to Embodiment 3.

FIG. 9 is a flowchart illustrating the operation of the propagation delay measurement system 90 according to Embodiment 4.

FIG. 10 shows a configuration example of the propagation delay measurement system 91 according to Embodiment 6.

### DESCRIPTION OF EMBODIMENTS

In the description of embodiments and the drawings, the same elements and the corresponding elements are given the same reference characters. Description on elements with the same reference characters are omitted or simplified as appropriate. Arrows in the drawings primarily indicate flow of data or flow of processing. Also, a “unit” can be read as a “circuit”, “step”, “procedure”, “process”, or “circuitry” as appropriate.

### Embodiment 1

The present embodiment is described in detail below with reference to drawings.

### ***Description of Configuration***

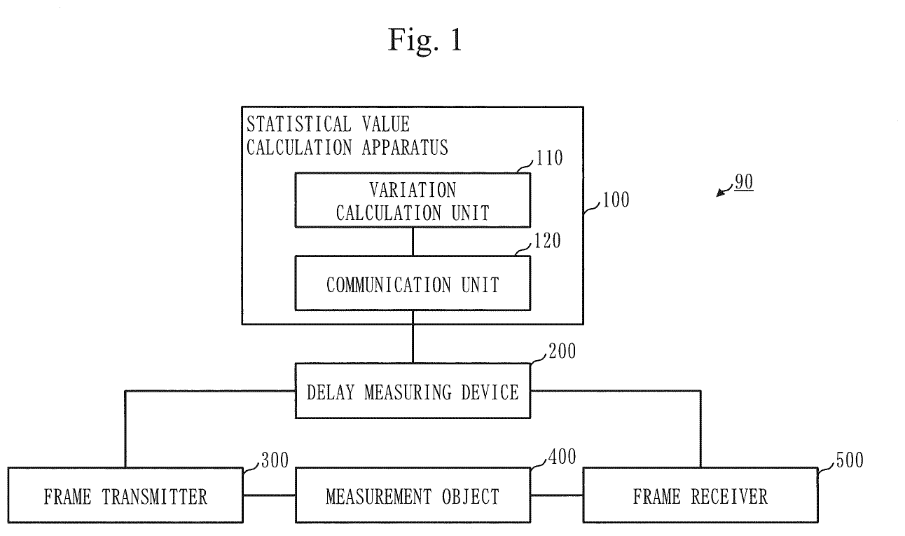

FIG. 1 shows a configuration example of a propagation delay measurement system 90 according to the present embodiment. The propagation delay measurement system 90 includes a statistical value calculation apparatus 100, a delay measuring device 200, a frame transmitter 300, a measurement object 400, and a frame receiver 500, as shown in FIG. 1. The statistical value calculation apparatus 100 and the delay measuring device 200 may also be integrally configured. The frame transmitter 300, the measurement object 400, and the frame receiver 500 may be components of an FA (Factory Automation) network.

The frame transmitter 300 and the measurement object 400, and the measurement object 400 and the frame receiver 500 are connected by a wired network. The wired network is a network compliant to Ethernet (registered trademark) standard as a specific example.

The delay measuring device 200 notifies the statistical value calculation apparatus 100 of the difference between a time of reception at the frame receiver 500 and a time of transmission at the frame transmitter 300 as the propagation delay. The delay measuring device 200 measures the propagation delay based on the difference between the time at which the frame transmitter 300 transmits a frame of interest and the time at which the frame receiver 500 receives the frame of interest.

The frame transmitter 300 repeatedly transmits frames to the frame receiver 500 in the wired network and notifies the delay measuring device 200 of the times of transmission of frames.

The measurement object 400 represents a relay for relaying data in the wired network and relays frames between the frame transmitter 300 and the frame receiver 500. Propagation delays occur at the measurement object 400.

The frame receiver 500 receives the frames transmitted by the frame transmitter 300 in the wired network and notifies the delay measuring device 200 of the times of reception of frames.

Propagation delay is a delay that occurs in communication over a wired network. Propagation delay is used for correcting time synchronization errors in an FA network, as a specific example. In the propagation delay measurement system 90 shown in FIG. 1, the propagation delay is the difference between the time at which the frame transmitter 300 transmits a frame of interest and the time at which the frame receiver 500 receives the frame of interest. The propagation delay is measured by calculating the difference between the time at which the frame transmitter 300 transmits the frame of interest and the time at which the frame receiver 500 receives the frame of interest which has passed through the measurement object 400 using the delay measuring device 200, as a specific example. The term “propagation delay” may refer to data indicating the propagation delay.

In conventional techniques, the value of the variation in the propagation delay is predicted by measuring propagation delays when the measurement object 400 in continuous operation repeatedly transfers frames and estimating the distribution of propagation delays based on the results of measurement. Accordingly, the fixed delay cannot be measured with the conventional techniques.

The present embodiment assumes a propagation delay model as a model indicating the variation in the propagation delay. The propagation delay model is a model indicating that the variation in the propagation delay consists of the variation in the variable delay and the variation in the fixed delay. A variable delay is a delay that varies while the measurement object 400 is in continuous operation. A fixed delay is a delay that varies each time the measurement object 400 is activated.

The statistical value calculation apparatus 100 includes a variation calculation unit 110 and a communication unit 120 as shown in FIG. 1.

When activation of the measurement object 400 is performed multiple times and multiple propagation delays at the measurement object 400 in continuous operation are measured each time activation of the measurement object 400 is performed, the variation calculation unit 110 measures the fixed delay based on multiple propagation delays measured at the measurement object 400 in continuous operation as an object fixed delay upon each activation of the measurement object 400. The variation calculation unit 110 then calculates the variation in the fixed delay based on the measured multiple object fixed delays. The variation calculation unit 110 may perform processing for calculating a mean value of all of the multiple propagation delays measured at the measurement object 400 in continuous operation as processing for measuring the fixed delay. The variation calculation unit 110 also measures the variable delay based on multiple propagation delays measured at the measurement object 400 in continuous operation and calculates the variation in the variable delay based on the result of measurement of the variable delay. The variation calculation unit 110 calculates the variation in the propagation delay based on the calculated variation in the fixed delay and the calculated variation in the variable delay.

The processing performed by the variation calculation unit 110 is described in more detail below. The variation calculation unit 110 receives multiple propagation delays from the delay measuring device 200 via the communication unit 120 when the measurement object 400 is in continuous operation, and performs a delay measurement process based on the multiple propagation delays received. The delay measurement process includes processing for measuring the distribution of propagation delays as the distribution of variable delays based on multiple propagation delays, and processing for calculating the mean value of all of the multiple propagation delays as the fixed delay. The mean value may be calculated based on any definition. The variation calculation unit 110 may perform processing for calculating each of the maximum value and the minimum value of the variable delay as the processing for measuring the distribution of variable delays. In this process, the variation calculation unit 110 updates the maximum value of the variable delay when the maximum value of the variable delay calculated from multiple propagation delays received is greater than the maximum value of the variable delay during execution of the delay measurement process, and updates the minimum value of the variable delay when the minimum value of the variable delay calculated from the multiple propagation delays received is smaller than the minimum value of the variable delay during execution of the delay measurement process. The variable delay can take a negative value. The variation calculation unit 110 may also perform the delay measurement process using propagation delays stored in, for example, a database that stores propagation delays measured by the delay measuring device 200.

For measuring the distribution of fixed delays, the measurement object 400 is reactivated multiple times. The variation calculation unit 110 performs the delay measurement process each time the measurement object 400 is reactivated. When reactivating the measurement object 400, at least any of the delay measuring device 200, the frame transmitter 300, and the frame receiver 500 may be reactivated in addition to the measurement object 400.

After that, the variation calculation unit 110 measures the distribution of fixed delays based on multiple fixed delays that were calculated by executing the delay measurement process multiple times. The variation calculation unit 110 then determines the sum of the variation obtained from the distribution of variable delays and the variation obtained from the distribution of fixed delays as the variation in the propagation delay. The variation calculation unit 110 may also perform processing for calculating each of the maximum and minimum values of the fixed delay as processing for measuring the distribution of fixed delays, as with the processing for measuring the distribution of variable delays.

Here, the variation in the propagation delay is represented by Formula 1. In Formula 1, “variation in variable delay” indicates the variation obtained from the distribution of variable delays. “Variation in fixed delay” indicates the variation obtained from the distribution of fixed delays.

“Variation in variable delay” is the maximum value of a range of the variable delay or a value estimated as the maximum value of the range of the variable delay, as specific examples. The range of the variable delay is the difference between the minimum value of the variable delay and the maximum value of the variable delay.

“Variation in fixed delay” is the range of observed fixed delays or a value estimated as the range of the fixed delay, as specific examples. The range of the fixed delay is the difference between the minimum value of the fixed delay and the maximum value of the fixed delay.

Each of the minimum value of the variable delay, the maximum value of the variable delay, the minimum value of the fixed delay, and the maximum value of the fixed delay may be an actually observed value, a value estimated from actually observed values, or a value theoretically calculated on the basis of the characteristics of the measurement object 400, a specification, or the like.

(Variation in propagation delay)=(variation in variable delay)+(variation in fixed delay) [FORMULA 1]

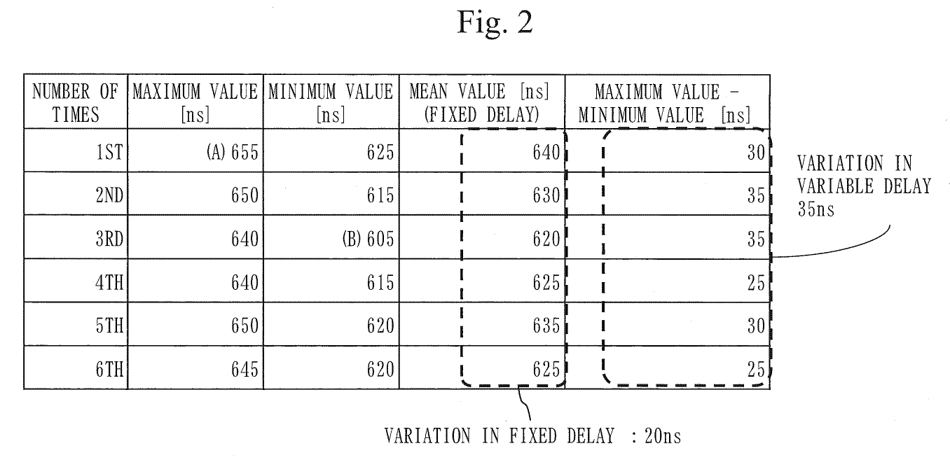

FIG. 2 is a table illustrating the variation in the propagation delay with a specific example of the results of measuring propagation delays. This example shows the measurement results for the case of activating the measurement object 400 six times. In the table shown in FIG. 2, the “Maximum value [ns]” column indicates the maximum values of the propagation delay in units of ns when the measurement object 400 is in continuous operation, and the “Minimum value [ns]” column indicates the minimum values of the propagation delay in units of ns when the measurement object 400 is in continuous operation. The “Mean value [ns]” column indicates the mean value of all of the observed propagation delays (that is, the fixed delay) in units of ns, and the “Maximum value-minimum value [ns]” column indicates the differences between the values in “Maximum value [ns]” column and the values in “Minimum value [ns]” column (that is, the range of the variable delay) in units of ns.

Since in this example the maximum value of the fixed delay is 640 ns and the minimum value of the fixed delay is 620 ns, the variation in the fixed delay is 20 ns. Also, since the maximum value of the range of the variable delay is 35 ns, the variation in the variable delay is 35 ns. Thus, in this example the variation calculation unit 110 obtains 55 ns (=35 ns+20 ns) as the variation in the propagation delay from Formula 1.

In this example, 655 ns shown in (A) is the largest propagation delay and 605 ns shown in (B) is the smallest propagation delay. Thus, as the variation in the actually observed propagation delays is 50 ns (=655 ns-605 ns), it seems that the variation calculation unit 110 can calculate an appropriate variation in the propagation delay according to Formula 1.

The communication unit 120 communicates with the delay measuring device 200.

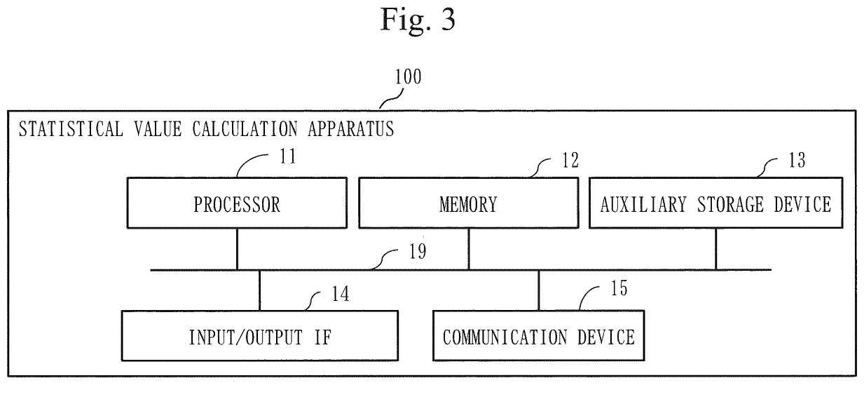

FIG. 3 shows a hardware configuration example of the statistical value calculation apparatus 100 according to the present embodiment. The statistical value calculation apparatus 100 is composed of a computer. The statistical value calculation apparatus 100 may be composed of more than one computer.

As shown in this diagram, the statistical value calculation apparatus 100 is a computer including pieces of hardware such as a processor 11, a memory 12, an auxiliary storage device 13, an input/output IF (Interface) 14, and a communication device 15. These pieces of hardware are appropriately connected via signal lines 19. The processor 11 is an IC (Integrated Circuit) that performs arithmetic

processing and controls the hardware included with the computer. The processor 11 can be a CPU (Central Processing Unit), a DSP (Digital Signal Processor), or a GPU (Graphics Processing Unit) as specific examples.

The statistical value calculation apparatus 100 may also include multiple processors to replace the processor 11. The multiple processors share the roles of the processor 11.

The memory 12 is typically a volatile storage device, and is a RAM (Random Access Memory) as a specific example. The memory 12 is also called a main storage device or a main memory. Data stored in the memory 12 is saved in the auxiliary storage device 13 as needed.

The auxiliary storage device 13 is typically a non-volatile storage device, and is a ROM (Read Only Memory), an HDD (Hard Disk Drive), or a flash memory as specific examples. Data stored in the auxiliary storage device 13 is loaded into the memory 12 as needed.

The memory 12 and the auxiliary storage device 13 may also be integrally configured.

The input/output IF 14 is a port to which input devices and output devices are connected. The input/output IF 14 is a USB (Universal Serial Bus) terminal as a specific example. The input devices are a keyboard and a mouse as specific examples. The output device is a display as a specific example.

The communication device 15 is a receiver and transmitter. The communication device 15 is a communication chip or a NIC (Network Interface Card) as specific examples.

The components of the statistical value calculation apparatus 100 may use the input/output IF 14 and the communication device 15 as appropriate when communicating with other devices or the like.

The auxiliary storage device 13 stores a statistical value calculation program. The statistical value calculation program is a program that causes a computer to implement the functions of the components provided in the statistical value calculation apparatus 100. The statistical value calculation program is loaded to the memory 12 and executed by the processor 11. The functions of the components included in the statistical value calculation apparatus 100 are implemented by software.

Data for use in execution of the statistical value calculation program, data resulting from execution of the statistical value calculation program, and the like are stored in a storage device as necessary. The components of the statistical value calculation apparatus 100 utilize the storage device as necessary. The storage device is formed of at least one of the memory 12, the auxiliary storage device 13, a register in the processor 11, and a cache memory in the processor 11. The storage device may be independent of the computer.

The functions of the memory 12 and the auxiliary storage device 13 may also be implemented by other storage device.

The statistical value calculation program may be recorded on a computer-readable, non-volatile recording medium. The non-volatile recording medium can be an optical disk or a flash memory as specific examples. The statistical value calculation program may be provided as a program product.

### ***Description of Operation***

An operational procedure of the statistical value calculation apparatus 100 corresponds to the statistical value calculation method. A program for enabling the operations of the statistical value calculation apparatus 100 corresponds to the statistical value calculation program.

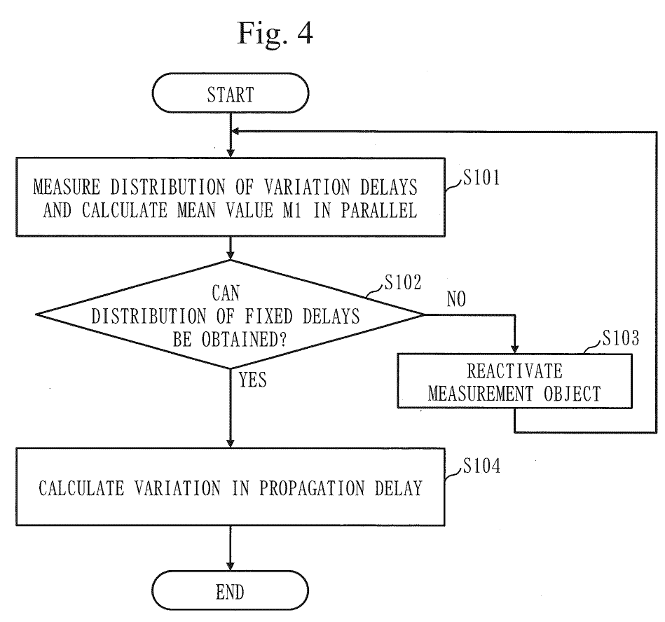

FIG. 4 is a flowchart illustrating an example of the operation of the propagation delay measurement system 90. With FIG. 4, the operation of the propagation delay measurement system 90 will be described.

### (Step S101)

The variation calculation unit 110 measures the distribution of propagation delays at the measurement object 400 in continuous operation as the distribution of variable delays, and calculates a mean value M1 as the fixed delay. The mean value M1 is the mean value of all of the propagation delays at the measurement object 400 in continuous operation and represents the fixed delay.

### (Step S102)

If the distribution of fixed delays can be obtained because the number of mean values M1 calculated at step S101 is sufficient, step S104 is performed. Otherwise, step S103 is performed.

### (Step S103)

The measurement object 400 is reactivated.

### (Step S104)

The variation calculation unit 110 calculates the variation in the propagation delay according to Formula 1. That is, the variation calculation unit 110 determines the sum of the variation in the variable delay obtained from the distribution of measured variable delays and the variation in the fixed delay obtained from the resulting distribution of fixed delays as the variation in the propagation delay.

***Description of effect of Embodiment 1***

As described above, according to the present embodiment, the variation in propagation delay that can occur at the measurement object 400 can be calculated more accurately by calculating the variation in the propagation delay on the basis of the variation in the variable delay and the variation in the fixed delay.

### ***Other Configurations***

### <Modification 1>

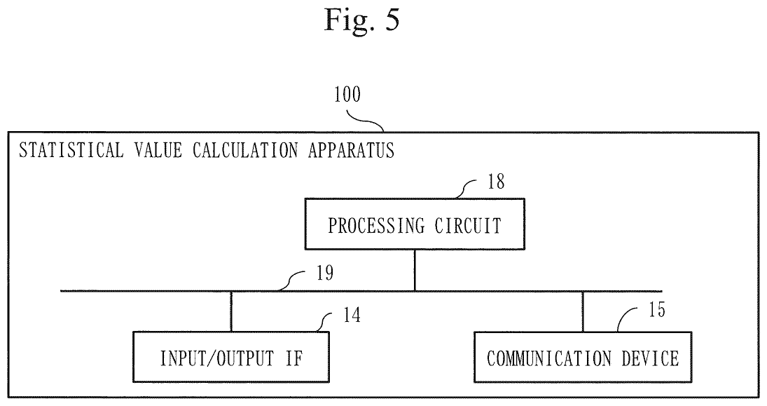

FIG. 5 shows a hardware configuration example of the statistical value calculation apparatus 100 according to this modification.

The statistical value calculation apparatus 100 includes a processing circuit 18 in place of the processor 11, the processor 11 and the memory 12, the processor 11 and the auxiliary storage device 13, or the processor 11, the memory 12 and the auxiliary storage device 13.

The processing circuit 18 is hardware that implements at least some of the components included in the statistical value calculation apparatus 100.

The processing circuit 18 may be dedicated hardware or may be a processor that executes programs stored in the memory 12.

When the processing circuit 18 is dedicated hardware, the processing circuit 18 can be a single circuit, a composite circuit, a programmed processor, a parallel-programmed processor, an ASIC (Application Specific Integrated Circuit), an FPGA (Field Programmable Gate Array), or a combination thereof, as specific examples.

The statistical value calculation apparatus 100 may include multiple processing circuits to replace the processing circuit 18. The multiple processing circuits share the roles of the processing circuit 18.

In the statistical value calculation apparatus 100, some of the functions may be implemented by dedicated hardware and the remaining functions may be implemented by software or firmware.

The processing circuit 18 is implemented by hardware, software, firmware, or a combination thereof, as specific examples.

The processor 11, the memory 12, the auxiliary storage device 13, and the processing circuit 18 are collectively called “processing circuitry”. That is, the functions of the functional components of the statistical value calculation apparatus 100 are implemented by the processing circuitry.

The statistical value calculation apparatuses 100 according to other embodiments may have a similar configuration to this modification.

### Embodiment 2

In the following, differences from the aforementioned embodiment are chiefly described with reference to drawings.

In the present embodiment, the variation in the variable delay and the variation in the fixed delay are calculated from the maximum and minimum values in the results of measuring propagation delays a predetermined number of times.

### ***Description of Configuration***

The configuration of the propagation delay measurement system 90 according to the present embodiment is similar to the configuration of the propagation delay measurement system 90 according to Embodiment 1.

The variation calculation unit 110 according to the present embodiment calculates the maximum and minimum values of the fixed delay based on the results of measurement of fixed delays and calculates the variation in the fixed delay based on the calculated maximum and minimum values of the fixed delay. The variation calculation unit 110 also calculates the maximum and minimum values of the variable delay based on the results of measurement of variable delays and calculates the variation in the variable delay based on the calculated maximum and minimum values of the variable delay.

The measurement object 400 according to the present embodiment is reactivated a first number of times of measurement. The propagation delay is measured a second number of times of measurement at the measurement object 400 in continuous operation.

Specifically, when the propagation delay has been reported N1 times (N1 being a natural number) during continuous operation of the measurement object 400, the variation calculation unit 110 records each of the mean value M1 of all the reported propagation delays and a maximum value MAX1 and a minimum value MIN1 calculated from the reported propagation delays. After that, the measurement object 400 is reactivated. After this cycle is repeated N2 times (N2 being a natural number), the variation calculation unit 110 records a maximum value MAX2 and a minimum value MIN2 from the recorded mean values M1, which serve as samples. Using these results, the variation in the propagation delay is calculated with Formula 2. Here, N1 and N2 each indicates a number of times of measurement and may be defined in any manner. The value of N1 represents the first number of times of measurement. The value of N2 represents the second number of times of measurement. The values of N1 and N2 may be different from each other. The mean value M1 indicates the mean value of all the propagation delays that were observed at the measurement object 400 in continuous operation. The maximum value MAX1 indicates the maximum value of all the variable delays that were observed at the measurement object 400 in continuous operation. The minimum value MIN1 indicates the minimum value of all the variable delays that were observed at the measurement object 400 in continuous operation. The maximum value MAX2 indicates the maximum value of all the calculated mean values M1. The minimum value MIN2 indicates the minimum value of all the calculated mean values M1. (Maximum value MAX2−minimum value MIN2) indicates the variation in the fixed delay. (Maximum value MAX1−minimum value MIN1) indicates the variation in the variable delay.

(Variation in propagation delay)=maximum value MAX2−minimum value MIN2+maximum value MAX1−minimum value MIN1 [FORMULA 2]

### ***Description of Operation***

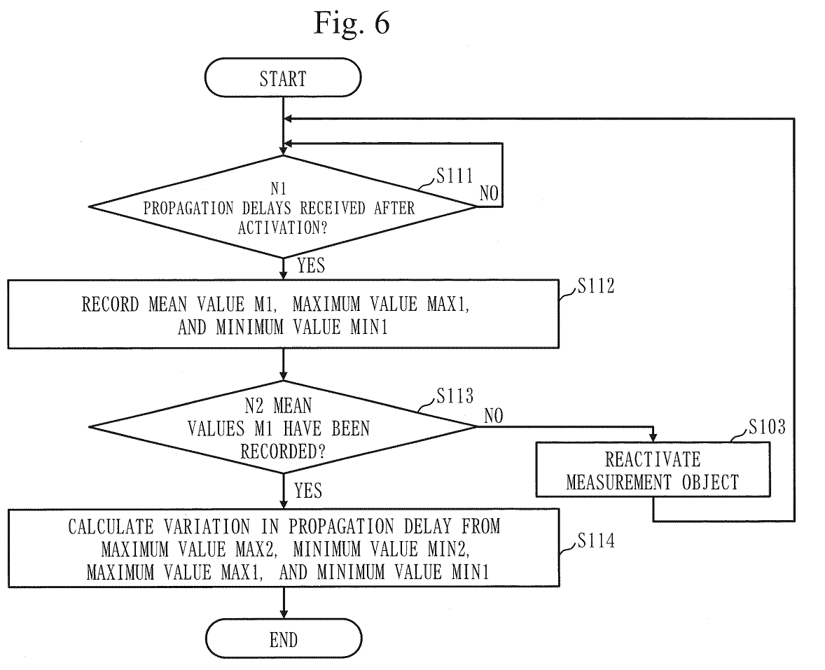

FIG. 6 is a flowchart illustrating an example of the operation of the propagation delay measurement system 90. With FIG. 6, the operation of the propagation delay measurement system 90 will be described.

### (Step S111)

If the variation calculation unit 110 has received N1 propagation delays after the activation of the measurement object 400, step S112 is performed. Otherwise, step S111 is repeatedly performed.

### (Step S112)

The variation calculation unit 110 calculates each of the mean value M1, the maximum value MAX1, and the minimum value MIN1 from the N1 propagation delays received, and records each of the calculated mean value M1, maximum value MAX1, and minimum value MIN1.

### (Step S113)

If the variation calculation unit 110 has recorded N2 mean values M1, step S114 is performed. Otherwise, step S103 is performed.

### (Step S114)

The variation calculation unit 110 calculates each of the maximum value MAX2 and the minimum value MIN2 based on the recorded N2 mean values M1, and records each of the calculated maximum value MAX2 and minimum value MIN2.

The variation calculation unit 110 then calculates the variation in the propagation delay according to Formula 2 with the recorded maximum value MAX2, minimum value MIN2, maximum value MAX1, and minimum value MIN1.

***Description of effect of Embodiment 2***

As described above, according to the present embodiment, even a simple statistical value calculation apparatus 100 that is incapable of calculating standard deviations can calculate the variation in the propagation delay at the measurement object 400.

Furthermore, by reactivating the measurement object 400 alone, the fixed delays of measurement errors become constant, that is, the fixed delays of measurement errors contained in the maximum value MAX2 and the minimum value MIN2 agree with each other. Thus, the fixed delays of measurement errors can be canceled by determining the difference between the maximum value MAX2 and the minimum value MIN2, which enables more accurate estimation of the variation in the propagation delay. A measurement error is an error contained in the propagation delay and is originated in a measuring instrument. A measuring instrument is a device for measuring propagation delays, composed of the delay measuring device 200, the frame transmitter 300, and the frame receiver 500 as a specific example.

### ***Other Configurations***

### <Modification 2>

In this modification, each of the first number of times of measurement and the second number of times of measurement is a number of times defined depending on a target measurement error in the variation in the propagation delay.

When N measurement values are obtained for each of N1 and N2, a standard deviation of samples consisting of the obtained measurement values will be ((N−1)/N)\hat{ }0.5 times the standard deviation in the population, and the difference between the maximum and minimum values is also expected to be ((N−1)/N)\hat{ }0.5 times the difference in the population. Here, the standard deviation in the population represents a theoretical value. Thus, this modification defines the value of each of N1 and N2 as a value of N that satisfies Formula 3 when a target error for the variation in the propagation delay is ±M % (where M≥0). When a digit of a significant figure i (i being a natural number) is necessary, the value of each of N1 and N2 is set to a value of N that satisfies Formula 4.

$$( ( N - 1 ) / N ) \hat{} 0.5 \geq 1 - M / 100 \qquad [ FORMULA 3 ]$$

$$( ( N - 1 ) / N ) \hat{} 0.5 > 1 - 0.5 * 10 \hat{} ( 1 - i ) \qquad [ FORMULA 4 ]$$

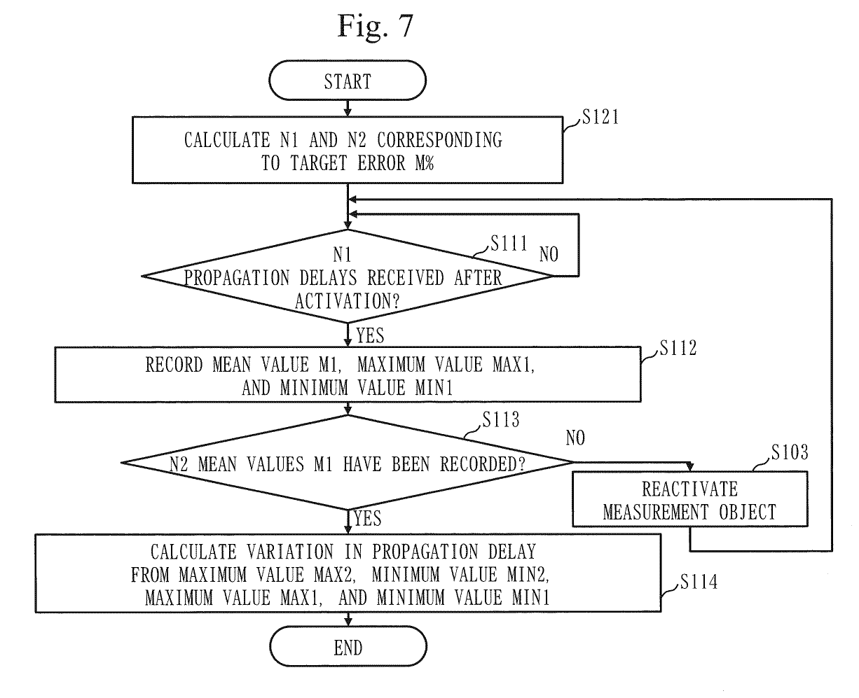

FIG. 7 is a flowchart illustrating an example of the operation of the propagation delay measurement system 90 according to this modification. With FIG. 7, the operation of the propagation delay measurement system 90 will be described.

### (Step S121)

When M % is input as the target error for the variation in the propagation delay, the variation calculation unit 110 sets the value of each of N1 and N2 to a value of N that satisfies Formula 3.

According to this modification, a variation in the propagation delay that satisfies the target error M % is expected to be calculated.

### Embodiment 3

In the following, differences from the aforementioned embodiment are chiefly described with reference to drawings.

The present embodiment is an application example of Embodiment 2.

### ***Description of Configuration***

The configuration of the propagation delay measurement system 90 according to the present embodiment is similar to the configuration of the propagation delay measurement system 90 according to Embodiment 1.

The variation calculation unit 110 according to the present embodiment calculates a standard deviation as a first standard deviation based on the result of measurement of the variable delay when the measurement object 400 is in continuous operation. When the first standard deviation has converged with a first accuracy, the measurement object 400 is reactivated. The variation calculation unit 110 also calculates the standard deviation as a second standard deviation based on the result of measurement of the fixed delay, and when the calculated second standard deviation has converged with a second accuracy, it calculates the variation in the fixed delay. Each of the first accuracy and the second accuracy may be defined in any manner.

Specifically, the variation calculation unit 110 measures a standard deviation S1 in each measurement of the variable delay and measures a standard deviation S2 in each measurement of the fixed delay. The standard deviation S1 represents the variation in the variable delay and corresponds to the first standard deviation. The standard deviation S2 represents the variation in the fixed delay and corresponds to the second standard deviation. The variation calculation unit 110 determines that the respective errors of the standard deviation S1 and standard deviation S2 with respect to the standard deviation in the population may be ignored at a point when each of the standard deviation S1 and the standard deviation S2 has converged with the necessary accuracy, and ends the measurement regardless of the values of N1 and N2. Here, the standard deviation S1 is the standard deviation of the variable delay. The standard deviation S2 is the standard deviation of the fixed delay. The necessary accuracies may be defined in any manner. The necessary accuracy corresponding to the standard deviation S1 and the necessary accuracy corresponding to the standard deviation S2 may be different from each other.

### ***Description of Operation***

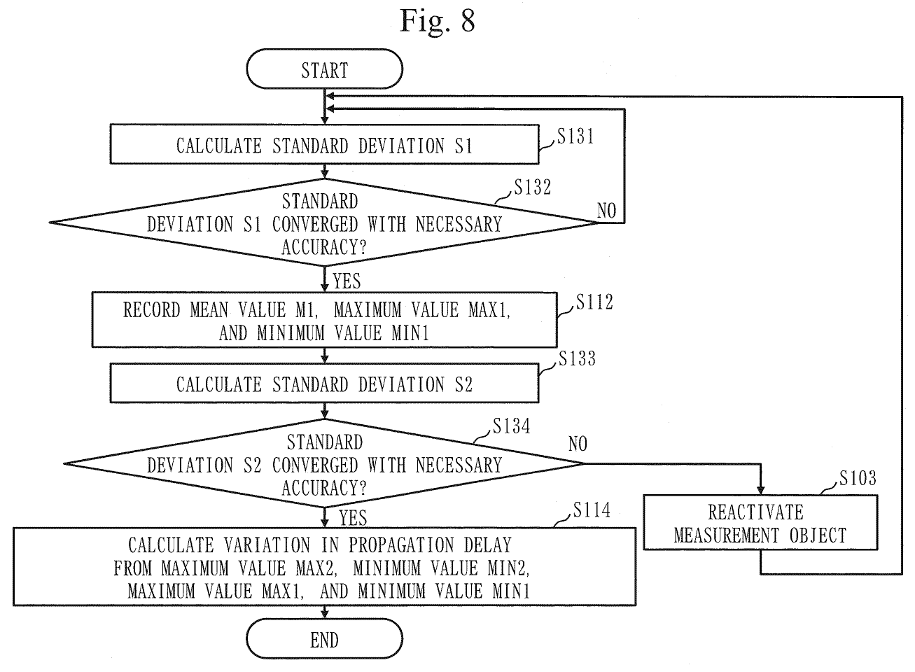

FIG. 8 is a flowchart illustrating an example of the operation of the propagation delay measurement system 90 according to the present embodiment. With FIG. 8, the operation of the propagation delay measurement system 90 will be described.

### (Step S131)

The variation calculation unit 110 calculates the standard deviation S1 using all of the propagation delays that have been received after the activation of the measurement object 400.

### (Step S132)

If the standard deviation S1 has converged with the necessary accuracy, step S112 is performed. Otherwise, step S131 is performed.

### (Step S133)

The variation calculation unit 110 calculates the standard deviation S2 using all of the mean values M1 recorded.

### (Step S134)

If the standard deviation S2 has converged with the necessary accuracy, step S114 is performed. Otherwise, step S103 is performed.

### ***Description of Effect of Embodiment 3***

According to the present embodiment, it is expected that a variation in the propagation delay that satisfies a predetermined target accuracy will be calculated.

### Embodiment 4

In the following, differences from the aforementioned embodiment are chiefly described with reference to drawings.

The present embodiment is an example of calculating the variation in the propagation delay based on a theoretical standard deviation when the distribution of propagation delays can be predicted.

### ***Description of Configuration***

The configuration of the propagation delay measurement system 90 according to the present embodiment is similar to the configuration of the propagation delay measurement system 90 according to Embodiment 1.

The variation calculation unit 110 according to the present embodiment calculates a standard deviation as a third standard deviation based on the result of measurement of the variable delay, calculates a standard deviation as a fourth standard deviation based on the result of measurement of the fixed delay, and calculates the variation in the propagation delay based on the calculated third standard deviation and the calculated fourth standard deviation. In this process, the variation calculation unit 110 calculates the variation in the propagation delay based on the third standard deviation and on a distribution that is likely to be followed by the variable delay as a specific example. The variation calculation unit 110 also calculates the variation in the propagation delay based on the fourth standard deviation and on a distribution that is likely to be followed by the fixed delay. The distribution that is likely to be followed by each of the variable delay and the fixed delay is a uniform distribution or a normal distribution as specific examples. The standard deviation S1 according to the present embodiment corresponds to the third standard deviation. The standard deviation S2 according to the present embodiment corresponds to the fourth standard deviation.

Specifically, the variation calculation unit 110 may calculate the variation in the propagation delay using the measured standard deviation S1 and standard deviation S2 when the distribution of propagation delays can be predicted. As a specific example, in a synchronization circuit using a common clock, much of the variation in the propagation delay results from clock domain crossing. Thus, the distribution of propagation delays is expected to a uniform distribution or a superposition of uniform distributions.

Here, the standard deviation of a uniform distribution is as shown in Formula 5. When each of the standard deviation S1 and the standard deviation S2 has converged with the necessary accuracy, each of the standard deviation S1 and the standard deviation S2 is considered to be sufficiently close to the theoretical value. Given that each of the standard deviation S1 and the standard deviation S2 is sufficiently close to the theoretical value, from Formula 5, the variation in the variable delay and the variation in the fixed delay in the population are each as shown in Formula 6. Considering that a uniform distribution is such that the distribution extends symmetrically on both sides of the mean value, the maximum value of the propagation delay and the minimum value of the propagation delay are each as shown in Formula 7. Hence, when the distribution of variable delays and the distribution of fixed delays are each a uniform distribution, the variation in the propagation delay is as shown in Formula 8. Here, the mean value M2 indicates the mean value in the distribution of propagation delays.

The variation calculation unit 110 may also calculate each of the maximum value of the propagation delay and the minimum value of the propagation delay according to Formula 9. Here, Max ( . . . ) indicates the maximum value in the parentheses and Min ( . . . ) indicates the minimum value in the parentheses.

$$( Standard deviation of a uniform distribution ) = ( ( maximum value ) - ( minimum value ) ) / 2 √ 3 \qquad [ FORMULA 5 ]$$

$$( Maximum value of variable delay ) - ( minimum value of variable delay ) = standard deviation S 1 * 2 √ 3 \\ ( Maximum value of fixed delay ) - ( minimum value of fixed delay ) = standard deviation S 2 * 2 √ 3 \qquad [ FORMULA 6 ]$$

$$( Maximum value of propagation delay ) = mean value M 2 + standard deviation S 1 * √ 3 + standard deviation S 2 * √ 3 \\ ( Minimum value of propagation delay ) = mean value M 2 - standard deviation S 1 * √ 3 - standard deviation S 2 * √ 3 \qquad [ FORMULA 7 ]$$

$$( Variation in propagation delay ) = ( maximum value of propagation delay ) - ( minimum value of propagation delay ) = ( standard deviation S 1 + standard deviation S 2 ) \times 2 √ 3 \qquad [ FORMULA 8 ]$$

$$( Maximum value of propagation delay ) = mean value M 2 + Max ( maximum value MAX 1 - mean value M 1 ) + Max ( maximum value MAX 2 - mean value M 2 ) = maximum value MAX 2 + Max ( maximum value MAX 1 - mean value M 1 ) \\ ( Minimum value of propagation delay ) = mean value M 2 + Min ( minimum value MIN 1 - mean value M 1 ) + Min ( minimum value MIN 2 - mean value M 2 ) = minimum value MIN 2 + Min ( minimum value MIN 1 - mean value M 1 ) \qquad [ FORMULA 9 ]$$

### ***Description of Operation***

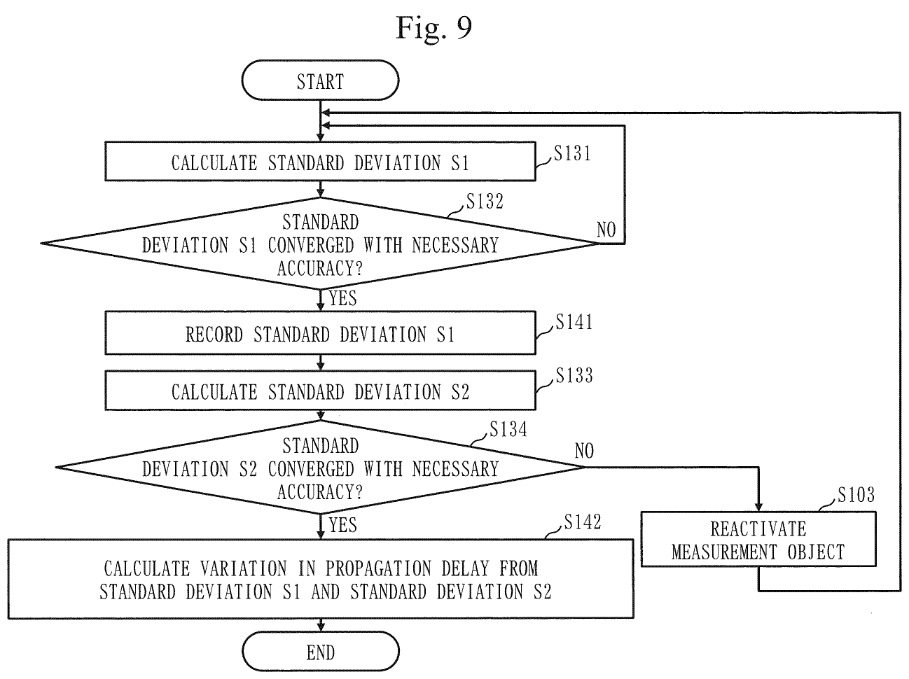

FIG. 9 is a flowchart illustrating an example of the operation of the propagation delay measurement system 90 according to the present embodiment. With FIG. 9, the operation of the propagation delay measurement system 90 will be described.

### (Step S141)

The variation calculation unit 110 records the calculated standard deviation S1.

### (Step S142)

The variation calculation unit 110 calculates the variation in the propagation delay according to Formula 8 using the calculated standard deviation S1 and standard deviation S2.

### ***Description of Effect of Embodiment***

According to the present embodiment, it is expected that the variation in propagation delay will be calculated with higher accuracy than when the variation in propagation delay is calculated with maximum and minimum values that are based on the results of measurement.

### ***Other Configurations***

### <Modification 3>

It may be assumed that only either of the fixed delay or the variable delay follows a uniform distribution in Embodiment 4. Assuming that only the fixed delay follows a uniform distribution, the maximum value of the propagation delay and the minimum value of the propagation delay are each as shown in Formula 10. Assuming that only the variable delay follows a uniform distribution, the maximum value of the propagation delay and the minimum value of the propagation delay are each as shown in Formula 11.

The variation calculation unit 110 according to this modification calculates the variation in the propagation delay according to Formula 10 or Formula 11.

$$( Maximum value of propagation delay ) = mean value M 2 + Max ( maximum value MAX 1 - mean value M 1 ) + standard deviation S 2 * √ 3 \\ ( Minimum value of propagation delay ) = mean value M 2 + Min ( minimum value MIN 1 - mean value M 1 ) + standard deviation S 2 * √ 3 \qquad [ FORMULA 10 ]$$

$$( Maximum value of propagation delay ) = mean value M 2 + standard deviation S 1 * √ 3 + Max ( maximum value MAX 2 - mean value M 2 ) = maximum value MAX 2 + standard deviation S 1 * √ 3 \\ ( Minimum value of propagation delay ) = mean value M 2 - standard deviation S 1 * √ 3 + Min ( minimum value MIN 2 - mean value M 2 ) = minimum value MIN 2 - standard deviation S 1 * √ 3 \qquad [ FORMULA 11 ]$$

### Embodiment 5

In the following, differences from the aforementioned embodiment are chiefly described.

The present embodiment is an example of calculating the variation in the propagation delay based on theoretical standard deviations when the distribution of propagation delays cannot be predicted.

### ***Description of Configuration***

The configuration of the propagation delay measurement system 90 according to the present embodiment is similar to the configuration of the propagation delay measurement system 90 according to Embodiment 1.

The variation calculation unit 110 according to the present embodiment assumes that the distribution that is likely to be followed by the fixed delay is a normal distribution and assumes that the distribution that is likely to be followed by the variable delay is a normal distribution. Specifically, when the distribution of propagation delays cannot be predicted, the variation calculation unit 110 assumes a normal distribution as the distribution of propagation delays as a specific example and calculates the variation in the propagation delay using a standard normal distribution table.

Here, it is necessary to create a situation where variable delays equal to or less than the minimum value MIN1 and variable delays equal to or more than the maximum value MAX1 are likely to no longer occur in the communications that are performed by the measurement object 400 in its lifetime. That is, it is required that the product of the number of communications that are performed by the measurement object 400 in its lifetime and the sum of the probability that a variable delay equal to or less than the minimum value MIN1 occurs in one communication and the probability that a variable delay equal to or more than the maximum value MAX1 occurs in one communication is 0.5 or less, as shown in Formula 12-1. Here, from the symmetry of a normal distribution, (the probability that a variable delay equal to or more than the maximum value MAX1 occurs) is the same as (the probability that a variable delay equal to or less than the minimum value MIN1 occurs). Therefore, Formula 12-1 is substantially the same as Formula 12-2. In addition, transform of Formula 12-2 gives Formula 13. The variation calculation unit 110 calculates the minimum value MIN1 by substituting the mean value M1 and the standard deviation S1 into a cumulative distribution function that satisfies Formula 13 and solving it. The variation calculation unit 110 then calculates the maximum value MAX1 according to Formula 17. When each of the variable delay and the fixed delay follows a normal distribution, Formula 16 holds. Transform of Formula 16 gives Formula 17.

For the fixed delay, it is also necessary to create a situation where fixed delays equal to or less than the minimum value MIN2 and fixed delays equal to or more than the maximum value MAX2 are likely to no longer occur, as with the variable delay. Thus, Formula 14 needs to be satisfied. In addition, transform of Formula 14 gives Formula 15. The variation calculation unit 110 calculates the minimum value MIN2 by substituting the mean value M3 and the standard deviation S2 into a cumulative distribution function that satisfies Formula 15 and solving it. The variation calculation unit 110 then calculates the maximum value MAX2 according to Formula 17. Here, the mean value M3 indicates the mean value of all the fixed delays.

The values to be substituted into the cumulative distribution functions may be calculated in any manner.

$$\{ ( Probability that a variable delay equal to or less than the minimum value MIN 1 occurs ) + ( probability that a variable delay equal to or more than the maximum value MAX 1 occurs ) \} * ( the number of communications performed by the measurement object 400 in its lifetime ) \leq 0.5 \qquad [ FORMULA 12 - 1 ]$$

$$( Probability that a variable delay equal to or less than the minimum value MIN 1 occurs ) * ( the number of communications performed by the measurement object 400 in its lifetime ) * 2 \leq 0.5 \qquad [ FORMULA 12 - 2 ]$$

$$( Probability that a variable delay equal to or less than the minimum value MIN 1 occurs ) \leq 0.5 / ( the number of communications performed by the measurement object 400 in its lifetime ) / 2 \qquad [ FORMULA 13 ]$$

$$( Probability that a fixed delay equal to or less than the minimum value MIN 2 occurs ) * ( the number of times the measurement object 400 is activated in its lifetime ) * 2 \leq 0.5 \qquad [ FORMULA 14 ]$$

$$( Probability that a fixed delay equal to or less than the minimum value MIN 2 occurs ) \leq 0.5 / ( the number of times the measurement object 400 is activated in its lifetime ) / 2 \qquad [ FORMULA 15 ]$$

$$Mean value M 1 = ( maximum value MAX 1 + minimum value MIN 1 ) / 2 \\ Mean value M 3 = ( maximum value MAX 2 + minimum value MIN 2 ) / 2 \qquad [ FORMULA 16 ]$$

$$Maximum value MAX 1 = 2 * mean value M 1 - minimum value MIN 1 \\ Maximum value MAX 2 = 2 * mean value M 3 - minimum value MIN 2 \qquad [ FORMULA 17 ]$$

After calculating the maximum and minimum values corresponding to the variable delay and the maximum and minimum values corresponding to the fixed delay as described above, the variation calculation unit 110 calculates the variation in the propagation delay according to Formula 18.

(Variation in propagation delay)=(difference between the maximum and minimum values corresponding to the variable delay)+(difference between the maximum and minimum values corresponding to the fixed delay) [FORMULA 18]

### ***Description of Operation***

The operation of the propagation delay measurement system 90 according to the present embodiment is similar to the operation of the propagation delay measurement system 90 according to Embodiment 4. Differences between the present embodiment and Embodiment 4 are discussed below.

### (Step S142)

The variation calculation unit 110 calculates the variation in the propagation delay according to Formula 18.

### ***Description of Effect of Embodiment 5***

According to the present embodiment, it is expected that the variation in propagation delay will be calculated with higher accuracy than when the variation in propagation delay is calculated with maximum and minimum values that are based on the results of measurement.

### Embodiment 6

In the following, differences from the aforementioned embodiment are chiefly described with reference to drawings.

### ***Description of Configuration***

The present embodiment uses the propagation delay measurement system 90 according to Embodiment 1 and a propagation delay measurement system 91 as propagation delay measurement systems. The term “propagation delay measurement system” is also a general term for the propagation delay measurement system 90 and the propagation delay measurement system 91.

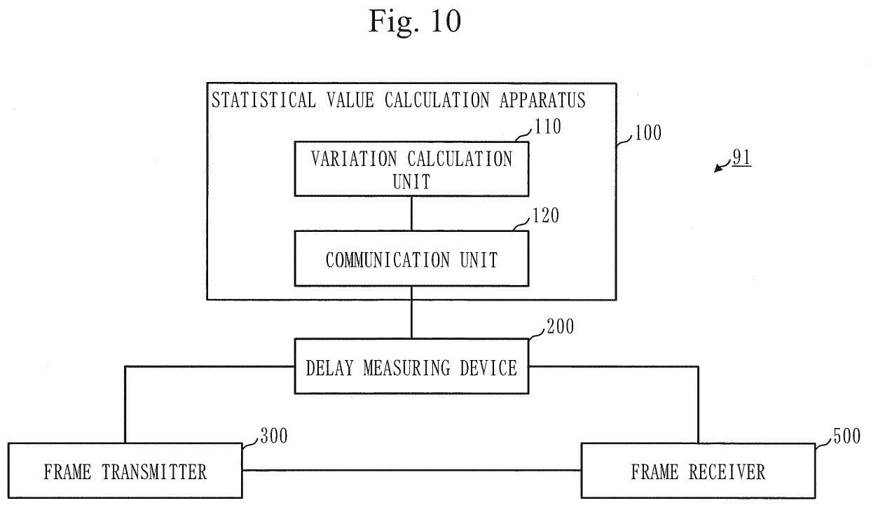

The propagation delay measurement system 91 includes the statistical value calculation apparatus 100, the delay measuring device 200, the frame transmitter 300, and the frame receiver 500 as shown in FIG. 10.

The propagation delay measurement system 90 is also called a first system. The propagation delay measurement system 91 is also called a second system.

As a propagation delay model indicating the variation in the propagation delay in the first system, assume a model that indicates that the variation in the propagation delay in the first system consists of a variation in a first variable delay and a variation in a first fixed delay. The first variable delay is a delay that varies when all the components of the first system are in continuous operation. The first fixed delay is a delay that varies each time all the components of the first system are activated.

As a propagation delay model indicating the variation in the propagation delay in the second system, assume a model that indicates that the variation in the propagation delay in the second system consists of a variation in a second variable delay and a variation in a second fixed delay. The second variable delay is a delay that varies when all the components of the second system are in continuous operation. The second fixed delay is a delay that varies each time all the components of the second system are activated.

If activation of all the components of the first system is performed multiple times and multiple propagation delays are measured in the first system in continuous operation each time activation of all the components of the first system is performed, the variation calculation unit 110 according to the present embodiment measures the first fixed delay based on multiple propagation delays measured in the first system upon each activation of all the components of the first system. The variation calculation unit 110 also measures the first variable delay based on multiple propagation delays measured in the first system in continuous operation. Thereafter, the variation calculation unit 110 calculates a first fixed standard deviation as a standard deviation based on the result of the measurement of the first fixed delay, and calculates a first variable standard deviation as a standard deviation based on the result of the measurement of the first variable delay.

Further, if activation of all the components of the second system is performed multiple times and multiple propagation delays are measured in the second system in continuous operation each time activation of all the components of the second system is performed, the variation calculation unit 110 measures the second fixed delay based on multiple propagation delays measured in the second system upon each activation of all the components of the second system. The variation calculation unit 110 also measures the second variable delay based on multiple propagation delays measured in the second system in continuous operation. Thereafter, the variation calculation unit 110 calculates a second fixed standard deviation as a standard deviation based on the result of the measurement of the second fixed delay, and calculates a second variable standard deviation as a standard deviation based on the result of the measurement of the second variable delay.

The variation calculation unit 110 then calculates the third standard deviation based on the first variable standard deviation and the second variable standard deviation, and calculates the fourth standard deviation based on the first fixed standard deviation and the second fixed standard deviation.

In the present embodiment, all of the components of the propagation delay measurement system are reactivated for measuring fixed delays.

In the present embodiment, in order to calculate the variation in the propagation delay at the measurement object 400 eliminating the measurement errors of the measuring instrument, the standard deviation is measured in each of the propagation delay measurement system 90 and the propagation delay measurement system 91, after which the variation in the propagation delay at the measurement object 400 is calculated by making use of the additivity of distribution. Specifically, the variation calculation unit 110 calculates the standard deviations according to Formula 19 and uses the calculated standard deviations to calculate the variation in the propagation delay at the measurement object 400. Here, “a configuration with the measurement object 400” corresponds to the propagation delay measurement system 90, and “a configuration without the measurement object 400” corresponds to the propagation delay measurement system 91.

The variation calculation unit 110 may also calculate the mean value of delays according to Formula 20 and use the calculated mean value to calculate the variation in the propagation delay at the measurement object 400.

$$( Standard deviation ) = \{ ( standard deviation in a configuration with the measurement object 400 ) \hat{} 2 - ( standard deviation in a configuration without the measurement object 400 ) \hat{} 2 \} \hat{} 0.5 \qquad [ FORMULA 19 ]$$

$$( Mean value ) = ( mean value in the configuration with the measurement object 400 ) - ( mean value in the configuration without the measurement object 400 ) \qquad [ FORMULA 20 ]$$

### ***Description of Operation***

The operation of the propagation delay measurement system 90 according to the present embodiment is similar to the operation of the propagation delay measurement system 90 according to Embodiment 4. Differences between the present embodiment and Embodiment 4 are discussed below.

### (Step S103)

All of the components of the propagation delay measurement system are reactivated.

### (Step S142)

This step is performed when the standard deviation S1 and standard deviation S2 in the propagation delay measurement system 90 have converged with the necessary accuracies and also the standard deviation S1 and standard deviation S2 in the propagation delay measurement system 91 have converged with the necessary accuracies.

The variation calculation unit 110 calculates each of the standard deviation S1 and standard deviation S2 corresponding to the measurement object 400 according to Formula 19 using the standard deviation S1 and standard deviation S2 in the propagation delay measurement system 90 and standard deviation S1 and standard deviation S2 in the propagation delay measurement system 91. The variation calculation unit 110 then calculates the variation in the propagation delay at the measurement object 400 using the calculated standard deviation S1 and standard deviation S2 corresponding to the measurement object 400 in the schemes shown in Embodiment 4 or Embodiment 5.

### ***Description of Effect of Embodiment 6***

According to the present embodiment, it is expected that the variation in propagation delay will be calculated with higher accuracy than when the variation in propagation delay is calculated with maximum and minimum values that are based on the results of measurement.

### Other Embodiments

Any combination of the embodiments described above, modification to any component in the embodiments, or omission of any component in the embodiments is possible.

Also, embodiments are not limited to the ones shown as Embodiments 1 to 6 and various modifications are possible as needed. Procedures described with flowcharts or the like may be modified as appropriate.

### REFERENCE SIGNS LIST

11: processor; 12: memory; 13: auxiliary storage device; 14: input/output IF; 15: communication device; 18: processing circuit; 19: signal line; 90, 91: propagation delay measurement system; 100: statistical value calculation apparatus; 110: variation calculation unit; 120: communication unit; 200: delay measuring device; 300: frame transmitter; 400: measurement object; 500: frame receiver

1. A statistical value calculation apparatus, which calculates variation in propagation delay that occurs at a measurement object which relays data, comprising:
processing circuitry
to calculate fixed delay, which varies each time the measurement object is activated, based on a plurality of propagation delays measured upon each activation of the measurement object, and
to calculate a variation in the fixed delay based on a plurality of fixed delays calculated upon a plurality of activations, wherein
the processing circuitry calculates variable delay, which varies while the measurement object is in continuous operation, a variation in the variable delay based on a plurality of propagation delays measured at the measurement object in continuous operation, and calculates the variation in the propagation delay based on the variation in the fixed delay and the variation in the variable delay.

2. The statistical value calculation apparatus according to claim 1, wherein
the processing circuitry determines a mean value of a plurality of propagation delays measured at the measurement object in continuous operation as the fixed delay.

3. The statistical value calculation apparatus according to claim 1, wherein
the processing circuitry calculates a maximum value and a minimum value of the fixed delay based on a result of calculation of the fixed delay, calculates the variation in the fixed delay based on the calculated maximum value and minimum value of the fixed delay, calculates a maximum value and a minimum value of the variable delay based on a result of calculation of the variable delay, and calculates the variation in the variable delay based on the calculated maximum value and minimum value of the variable delay.

4. The statistical value calculation apparatus according to claim 1, wherein
the measurement object is reactivated a first number of times of measurement, and the propagation delay is measured a second number of times of measurement at the measurement object in continuous operation.

5. The statistical value calculation apparatus according to claim 2, wherein
the measurement object is reactivated a first number of times of measurement, and the propagation delay is measured a second number of times of measurement at the measurement object in continuous operation.

6. The statistical value calculation apparatus according to claim 3, wherein
the measurement object is reactivated a first number of times of measurement, and the propagation delay is measured a second number of times of measurement at the measurement object in continuous operation.

7. The statistical value calculation apparatus according to claim 4, wherein
each of the first number of times of measurement and the second number of times of measurement is a number of times defined depending on a target measurement error in the variation in the propagation delay.

8. The statistical value calculation apparatus according to claim 5, wherein
each of the first number of times of measurement and the second number of times of measurement is a number of times defined depending on a target measurement error in the variation in the propagation delay.

9. The statistical value calculation apparatus according to claim 6, wherein
each of the first number of times of measurement and the second number of times of measurement is a number of times defined depending on a target measurement error in the variation in the propagation delay.

10. The statistical value calculation apparatus according to claim 1, wherein
the processing circuitry calculates a standard deviation as a first standard deviation based on a result of calculation of the variable delay when the measurement object is in continuous operation,
when the first standard deviation has converged with a first accuracy, the measurement object is reactivated, and
the processing circuitry calculates a standard deviation as a second standard deviation based on a result of calculation of the fixed delay, and when the calculated second standard deviation has converged with a second accuracy, calculates the variation in the propagation delay using maximum values and minimum values of the fixed delay and the variable delay.

11. The statistical value calculation apparatus according to claim 10, wherein
the processing circuitry calculates a standard deviation as a third standard deviation based on a result of calculation of the variable delay, calculates a standard deviation as a fourth standard deviation based on a result of calculation of the fixed delay, and calculates the variation in the propagation delay based on the calculated third standard deviation and the calculated fourth standard deviation.

12. The statistical value calculation apparatus according to claim 11, wherein
the processing circuitry
calculates the variation in the propagation delay based on the third standard deviation and on a distribution that is likely to be followed by the variable delay, and
calculates the variation in the propagation delay based on the fourth standard deviation and on a distribution that is likely to be followed by the fixed delay.

13. The statistical value calculation apparatus according to claim 12, wherein
the processing circuitry assumes that the distribution that is likely to be followed by the fixed delay is a normal distribution and assumes that the distribution that is likely to be followed by the variable delay is a normal distribution.

14. A propagation delay measurement system, which comprises two statistical value calculation apparatuses according to claim 11, wherein
the processing circuitry calculates the third standard deviation based on two said first standard deviation calculated by the two statistical value calculation apparatuses, and calculates the fourth standard deviation based on two said second standard deviation calculated by the two statistical value calculation apparatuses.

15. A statistical value calculation method, which calculates variation in propagation delay that occurs at a measurement object which relays data, comprising:
by a computer, calculating fixed delay, which varies each time the measurement object is activated, based on a plurality of propagation delays measured upon each activation of the measurement object, and
by the computer, calculating a variation in the fixed delay based on a plurality of fixed delays calculated upon a plurality of activations, wherein
the computer calculates variable delay, which varies while the measurement object is in continuous operation, a variation in the variable delay based on a plurality of propagation delays measured at the measurement object in continuous operation, and calculates the variation in the propagation delay based on the variation in the fixed delay and the variation in the variable delay.

16. A non-transitory computer readable medium storing a statistical value calculation program, which calculates variation in propagation delay that occurs at a measurement object which relays data, that causes a statistical value calculation apparatus that is a computer to:
execute a variation calculation process of
calculating fixed delay, which varies each time the measurement object is activated, based on a plurality of propagation delays measured upon each activation of the measurement object, and
calculating a variation in the fixed delay based on a plurality of fixed delays calculated upon a plurality of activations, wherein
the variation calculation process calculates variable delay, which varies while the measurement object is in continuous operation, a variation in the variable delay based on a plurality of propagation delays measured at the measurement object in continuous operation, and calculates the variation in the propagation delay based on the variation in the fixed delay and the variation in the variable delay.
